(19) United States
(12) Patent Application Publication
(10) Pub. No.: US 2002/0009071 A1
(43) Pub. Date: Jan. 24, 2002

(54) COMMUNICATION SYSTEM AND A METHOD FOR PERFORMING TELEPHONE CALLS

(76) Inventors: EREZ YAARY, TEL-AVIV (IL); OFER SHEM TOY, RAMAT GAN (IL)

Correspondence Address: HELFGOTT & KARAS P C, EMPIRE STATE BUILDING, 60TH FLOOR, NEW YORK, NY, 101180110

(21) Appl. No.: 09/306,626

(22) Filed: May 6, 1999

(51) Int. Cl. H04L 12/66

(52) U.S. Cl. 370/352; 370/386

(57) ABSTRACT

A communication system and a method for performing telephone calls over hybrid network using a web page. The communication system includes a computer system having an Internet browser application for browsing the internet, at least one audio input device, at least one audio output device and a communication mean for communicating with said hybrid network. The system further includes a telephony communication means operably coupled to a web page for performing telephone calls, an addressing server for resolving a telephony call parameters and for providing destination parameters and a bridging device operably coupled to the addressing bridging device for receiving said destination parameters and for deliver said parameters to the PSTN for establish said telephone call.

### COPYRIGHT

A portion of the disclosure of this patent document contains material that is subject to copyright protection. The copyright owner has no objection to the facsimile reproduction by anyone of the patent disclosure, as it appears in the Patent and trademark office patent file or records, but otherwise reserve all copyright whatsoever.

### FIELD OF THE INVENTION

The present invention relates to a telephony system and in particular to a system, method and apparatus for performing telephone call from an Internet browser.

### BACKGROUND OF THE INVENTION

Communication networks, such as wide area networks (WAN), are commonly known, and perhaps the fastest growing of these is the Internet. A hybrid network is a combination of communication networks, which typically includes a local area network (LAN), a switched telephony network (STN) and the Internet. One Internet application, known as audio transceiver, enables users to transmit and receive audio over the Internet. An example of this application, known as Internet telephony client, allows for telephone calls over the Internet. The Internet telephony client is computer software. The software includes a graphical unit interface (GUI) which enables a user to perform telephone calls and follows the call process.

Typically, the user is browsing (“surf”) the Internet by using an Internet browsing application such as “Internet Explorer” of Microsoft® Corporation, One Microsoft Way, Redmond, Wash. 98052-6399 U.S.A. Typically, browsing the Internet is browsing through web pages. Typically, a web page is a virtual company site that includes information about the company. Typically, an address, a telephone number, a fax number, an e-mail address, a commercial information of the company products and etc. When the user arrives, for example, to a site of a company that he wishes to contacts, the user can not perform a telephone call from the browser. The user needs to use a stand-alone Internet telephony application to call the said company from his computer while surfing or to use a standard telephone device, which is typically connected to a second telephone line.

The disadvantage of using standard telephone is that the user needs at least one telephone line for connecting the Internet and other telephone line for performing and receiving telephone calls.

The disadvantage of using the Internet telephony application is that the application adds load to the computer memory and the user have to switch from the Internet telephony application to the Internet browser application. Thus, there is a need for a telephony communication system and a method that enable the user to surf the Internet and perform telephone calls simultaneously.

### SUMMARY OF THE INVENTION

The present invention improves on the prior art of hybrid network telephony application by providing a system and a method for performing telephone calls from an Internet browser. This system involves hardware and software with the method for performing the same.

In a first aspect of the present invention there is provided a communication system for performing telephone calls over hybrid network. The hybrid network includes a combination of at least one of a public switched telephony network (PSTN) and a local area network (LAN) with a wide area network (WAN). The system includes a computer system having an Internet browser application for browsing the internet, at least one audio input device, at least one audio output device and a communication device for communicating with said hybrid network. The system further includes a telephony communication means operably coupled to a web page which displayed by said Internet browser for performing telephone calls, an addressing server links to the WAN for resolving telephony call parameters and providing at least one address of a bridging device and the bridging device is operably coupled to the WAN and the PSTN for receiving a destination parameters from said communication means and for delivering said parameters to the PSTN for establish a telephone call.

Advantageously, a user can build a web page to perform telephone calls, which suit to his needs. Furthermore, a user can call directly from a commercial web page without the need of external hybrid network telephony application. Only a single standard telephone line can be use to perform telephone calls while browsing the Internet.

In the preferred embodiment of the invention the, telephony call parameters are download from said web page to said telephone communication means.

In the preferred embodiment of the invention, the addressing server is locating said bridging device address and providing said bridging device address to the telephony communication means.

In the preferred embodiment of the invention, the telephony communication means are linking to said bridging device by said bridging device address and transfer a telephone destination parameters to said bridging device.

In the preferred embodiment of the invention, the bridging device transfers at least one of destination number and Internet protocol (IP) address to PSTN for establishing telephone call.

Typically, the telephony communication means comprises a software application which links to said web page.

In the preferred embodiment of the invention, the telephony application means includes a voice encoder for converting analog voice to digital signals, a voice decoder for converting digital signal to voice and a graphical universal interface (GUI) which links to said web for activating said telephony communication means.

Preferably, the GUI is a button and pressing on the button is activating or deactivating the telephony communication means.

Preferably, the button comprises animation for displaying a telephone call status.

In the preferred embodiment of the invention, the web page comprises a telephone number and by pressing on said button establishing a telephone call to a destination provided by said telephone number.

In the preferred embodiment of the invention, the web page comprises an Internet protocol (IP) address and by pressing on said button establishing a telephone call to a destination provided by said IP address.

In the second aspect of the present invention there is provided a method for performing telephone calls over hybrid network. The network includes a combination of at least one of a public switched telephony network (PSTN) and a local area network (LAN) with a wide area network (WAN). The method includes the steps of browsing said WAN to a virtual site which includes a telephony call parameters, downloading said telephony call parameters by a telephony communication means, contacting an addressing bridging device links to the WAN for resolving said telephony call parameters for providing a telephone call destination parameters, contacting to a bridging device which is operably coupled to the addressing server and links to the WAN and to the PSTN for receiving said destination parameters and delivering said parameters to the PSTN for establishing said telephone call.

Preferably, the telephony call parameters are download from said web page by said telephone communication means.

Preferably, said addressing serve is locating and providing said bridging device address to the telephony communication means.

Preferably, the telephony communication means are linked to said bridging device by said bridging device address for transferring said telephone destination parameters.

Preferably, the telephone destination parameters includes a destination number and IP address and said bridging device transfers at least one of the destination number and the IP address to PSTN for establishing said call.

In the preferred embodiment of the invention, the telephony communication means includes an Internet telephony software application which links to said web page.

In the preferred embodiment of the invention, the bridging device transfers telephony parameters from the WAN to the PSTN.

In the third aspect of the present invention there is provided a method for establishing a telephone call from a web page. The method includes the steps of providing a destination parameters for establishing a telephone call, downloading said parameters by a Internet telephony software application, contacting to an addressing server for receiving a bridging device address, contacting to said bridging device for providing said parameters and establishing a telephony call.

Preferably, the step of establishing further includes the step of contacting a public switched telephony network by said bridging device and providing at least one of a telephone number and an IP address for establishing said telephone call.

In the preferred embodiment of the invention, the Internet telephony software application comprises a voice encoder, a voice decoder and a network communication device for communicating over the wide area network In the preferred embodiment of the invention, the bridging device is for transferring telephony parameters from a wide area network to said public switched telephony network.

Preferably, the wide area network is the Internet.

### BRIEF DESCRIPTION OF THE DRAWINGS

The present invention will be described with reference to the accompanying drawings, wherein like reference numerals and/or characters identify corresponding or like components. In the drawings:

FIG. 1 is a communication system in accordance with the invention;

FIG. 2 is a block diagram of an apparatus for performing telephone call from a web page, in accordance with the invention.

FIG. 3 is a graphical interface of a Internet telephony application;

FIG. 4 is a flowchart of a method for performing a telephone call from a web page; and

FIG. 5 is an example of a web page in accordance with the invention.

### DETAILED DESCRIPTION OF THE DRAWINGS

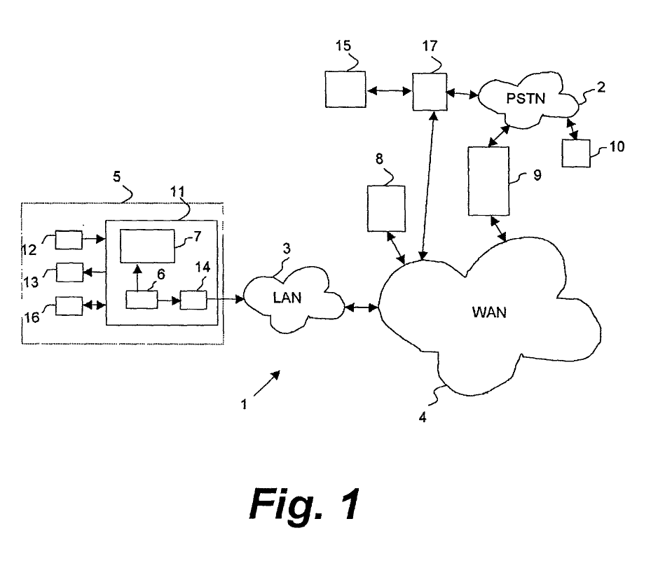

Referring firstly to FIG. 1, A communication system for performing telephone calls over hybrid network is shown. The communication system 1 includes a public switched telephony network (PSTN) 2, a local area network (LAN) 3, a wide area network (WAN) 4 such as the Internet, a computer system 5, a telephony communication means 6 operably coupled to a web page 7, an addressing server 8, a bridging device 9 and a telephone device 10. The computer system 5 is typically a personal computer (PC) which runs Windows® operating system and include an Internet browser application 11 such as “Internet Explorer” of Microsoft Corporation for browsing the internet, an audio input device 12 for, example microphone, an audio output device 13, for example loudspeaker, a pointing device 16, for example a mouse and a communication mean 14, for example a modem for communicating PSTN 2 or a LAN card for connecting with the LAN 3. The communication system 1 further includes an Internet service provider (ISP) 17 and a second computer system 15. The second computer system 15 includes an Internet telephony application for performing a computer to computer telephone call. The communication system 1, which is typically a telecommunication system which provides Internet telephony services, further includes an Internet service provider (ISP) 17 and a second computer system 15. The ISP 17 is linked to the PSTN 2 and to the WAN 4 and provides Internet services such as browsing to users. The second computer system 15 includes means for performing telephony calls over the hybrid network.

The hybrid network is a combination of each of the above networks (LAN, WAN, PSTN) with each other.

The communication system 1 is typically a telecommunication system which can provide Internet telephony services.

There are at least two types of Internet telephony services which can be provided by the communication system 1. The first service is known in the art as a ‘PC-to-Phone’ service and the second service is known in the art as a ‘PC-to-PC’ service.

The PC-to-Phone’ service is when a user is establishing a telephone call from his personal computer to which links to the Internet to a telephone device which links to the PSTN.

The ‘PC to PC’ service is when a user establish a telephone call from his personal which links to the Internet to another personal computer which links to the Internet.

The ‘PC to Phone’ service will be described now with reference to FIG. 1. In operation, a user is browsing the Internet using the Internet browser application 11. When the user arrived to a web page 7 which includes call parameters, the Internet browser application 11 identified that the web page 7 contains the telephony communication means 6. Typically, the telephony communication means 6 is a plug-in software which links to the web page 7. The browser 11 automatically downloads and installs the plug in software using the browser 11 automatic installation feature. The automatic installation feature of the browser is not a standard tool and varied from browser to browser. An example of web page source that includes commands to operate the automatic installation feature is shown in Appendix C. The plug-in software can also be installed manually by the user. After the installation, the telephony communication means 6 (plug-in software) appears as a graphic user interface (GUI) on the web page 7. The GUI is typically a graphical button that includes visual means for showing a telephony call status. A detailed description of the GUI will be described later with reference to FIG. 3. To start a call the user uses the computer system 5 pointing device 16. The user points and clicks on the button for performing the call. The telephony communication means 6 download the telephony call parameters from the web page 7 and transfers the call parameters by using the communication means 13, for example a LAN card, to the addressing server 8. The call parameters typically includes the following parameters: an addressing server parameters, a caller parameters, a destination parameters, an audio transceiver parameters and GUI parameters.

The addressing server parameters include a list of addressing server addresses that are in the format of Internet Protocol (IP) address and IP host names.

The caller parameters typically include a caller name, a caller telephone number and a caller e-mail address.

The destination parameters include a destination telephone number, a destination IP address and destination e-mail.

The audio transceiver parameters include codec type, for example G.723.1 codec frames packaging information and redundancy information.

The GUI information includes a button background and a button color.

The addressing server 8 links to the WAN 4 and resolves the telephony call parameters which are typically the caller parameters and the destination parameters, to locates the bridging device address and to provide the call destination parameters. The addressing server 8 return to the telephony communication means 6 the bridging device address. The telephony communication means 6 links to the bridging device 9 and transfers telephone destination parameters. The bridging device 9 is operably coupled to the addressing server 8 and links to the WAN 4 and to the PSTN 2. The bridging device 9 receives the destination parameters and delivers the parameters to the PSTN 2 for establish said telephone call. The PSTN 2 contacts the telephone device 10. The callee answers the call and the call is established. In a ‘PC to PC’ service, the user of first computer system 5 dials to the user of the second computer system 15. The user of the first computer system 5 initiates the call by clicking on the button of the web page 7. The telephony communication means 6 download the telephony call parameters from the web page 7 and transfers the call parameters by using the LAN card, to the addressing server 8. The addressing server 8 resolves the telephony call parameters which are typically the caller parameters and the destination parameters, to locates the bridging device address and to provide the call destination parameters. The addressing server 8 return to the telephony communication means 6 the bridging device address. The telephony communication means 6 links to the bridging device 9 and transfers telephone destination parameters. The destination parameters include the ISP IP address, the second computer IP address and ISP telephone number. The bridging device 9 receives the destination parameters and delivers the parameters to the PSTN 2. The PSTN 2 contacts the IPS 17 and transfers the IP address of the second computer system 15. The IPS contacts the computer system 15. The computer system 15 detects the telephony call and automatically lunches an Internet telephony application to answer the call.

Typically, the addressing server 9 is a Gatekeeper which is detailed described in USA patent U.S. Ser. No. 08/731,848 “A System And Method For Personal Multimedia Communication Over A Packet Switched Network”.

Appendix A, “VocalTec Ensemble Architecture” describe the Internet telephony system specification of the present invention.

Typically, the bridging device 9 is a gateway which is detailed described in Appendix B “VocalTec Telephony Gateway 3.3” white paper.

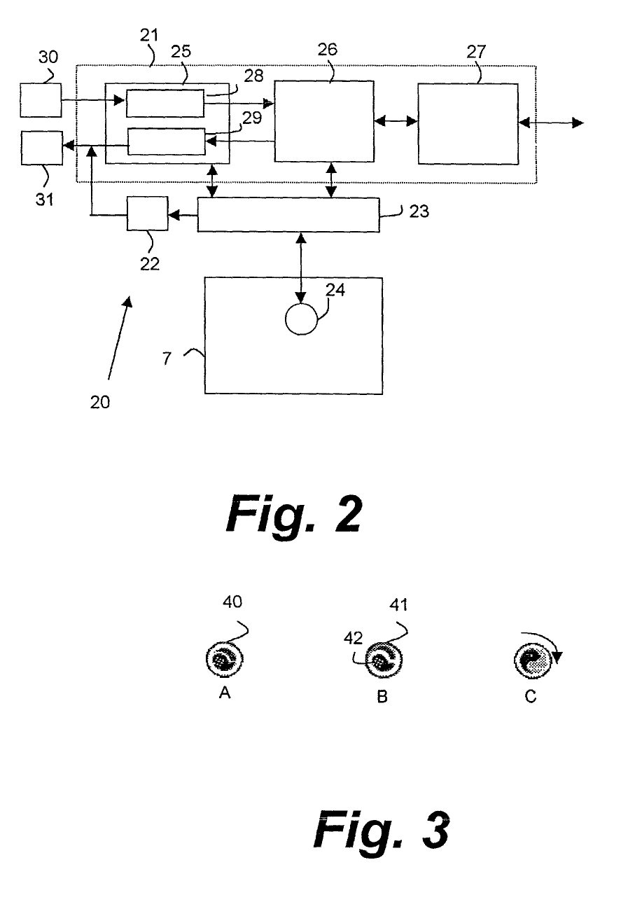

Referring now to FIG. 2, an apparatus for establishing a telephony call from a web page is shown. The apparatus 20 includes an audio transceiver 21, a tone generator 22, a controller 23, a plug-in software 24 which links to the web page 7. The audio transceiver 21 includes a codec 25, a packager 26 and a network communication device 27. The codec 25 is typically an International Telecommunication union (ITU) standard G.723.1 or G.729 a codec which includes a voice encoder 28 and a voice decoder 29. The voice encoder 28 is connected to a microphone 30 and the voice decoder 29 is connected to a loudspeaker 31.

In operation, the plug-in software 24 links to the web page 7 and typically appears to the user us a graphical button. By pressing on the graphical button the user can establish a telephone call as it was described above. During the call the user speaks to the microphone 30 the voice encoder 28 converts the voice into voice samples. The packager 26 package the data in accordance with Internet protocol and use the codec 25 parameters for packaging the voice samples in accordance with the audio transceiver parameters. The network communication device 27 transfers the data over the hybrid network to the callee. When receiving voice from the callee, the network communication device 27 receives packets of data and transfers them to the packager 26. The packager 26 unpacks the voice samples from the data packets and transfers them to the voice decoder 29. The voice decoder 29 converts the voice sample into voice and plays the voice on the loudspeaker 31. The controller 23 controls the apparatus by transferring commands from the plug-in software to the apparatus 20 blocks. The tone generator 22 is used to play telephone tones such as rings and busy tons on the computer speaker.

Referring now to FIG. 3 an example of the GUI is shown. The GUI is a graphical button 40 that includes animated part. The GUI links to the web page 7 for activating the telephony communication means 6. The button in A is shown in idle status. The idle status is when there is no telephone call in progress. The button 40 includes two parts the first part is for example, a telephone handset 41 and the second part is, for example is a telephone base 42. As is shown in B, pressing on the button 40 causes the telephone handset 41 to move up and down while the telephone rings. When the callee answers the call the button 40 start to rotate in the arrow direction as it shows in C. A second press on the button 40 deactivates the telephony communication means 6 and terminating the call. The button 40 stops to rotation and return to idle status as is shown in A.

Audio indications are provided to improve the human interface with the web page 7. An example for such audio indications are ringing tones until the telephone device 10 answers, ‘busy’ tone when the telephone device 10 is busy, dialing tones while dialing a telephone number. The above indications are an example only and other audible indication can be use with the present invention. Other indication such as text indication can be provided on the Internet browser 11 status bar. An example for such indications is error messages, an information of addressing server discovery, an information of bridging device call setup progress and an information on call disconnection reasons.

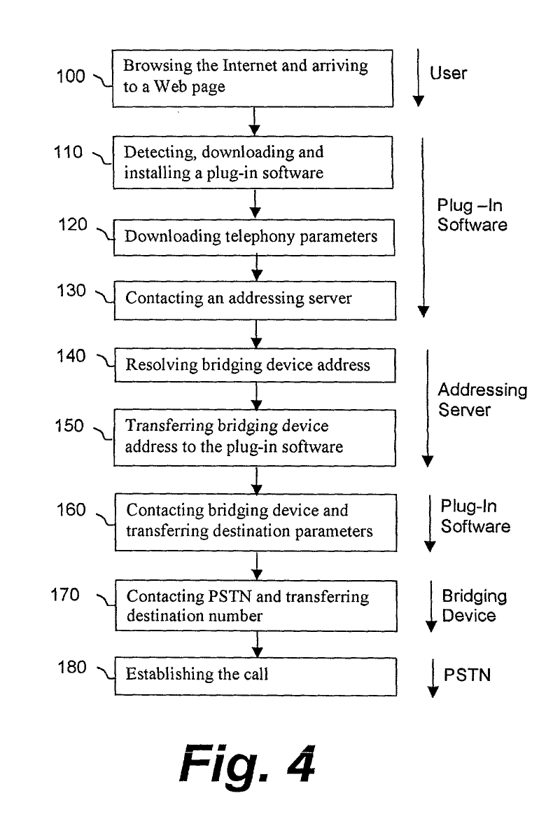

Referring to FIG. 4 a method for performing a telephone call from a web page 7 his shown. The first step, step 100 is browsing the Internet and arriving to a web page which includes telephony call parameters. The browser 11 detects the presents of the telephony call parameters and automatically downloads and installs the plug in software using the browser 11 automatic installation feature, step 110. The plug-in software, which is a part of the telephony communication means 6 downloads the telephony call parameters from the web page 7, step 120. The next step, step 130 the plug-in software contact the addressing server 8. The addressing server 8, resolves the address of the nearest bridging device 9, step 140. The addressing server 8 transfers the address to the plug in software which links to web page 7, step 150. The plug-in software contacts the bridging device 9 and transfers the destination parameters, step 160. The bridging device 9 contacts the PSTN and transfers the destination parameter step 170. At that time the telephony communication means 6 playing the dial tones, ringing tones using the tone generator 22, to the user. Typically, the dial tones are sound like dual tone medallion frequencies (DTMF). Step 180, the PSTN dial to the destination telephone device to establish the call. The user call talks now with a callee of the destined telephone device 10. Typically, the telephony communication means 6 includes a codec, for example a G.723 codec, for converting the voice of the caller to a digital signals and transfers it to the callee by using Internet protocol (IP) and for converting the callee digital signals to voice. Typically, the bridging device 9 includes a codec for converting voice from PSTN to digital signal in IP format and for converting digital signal in IP format to voice.

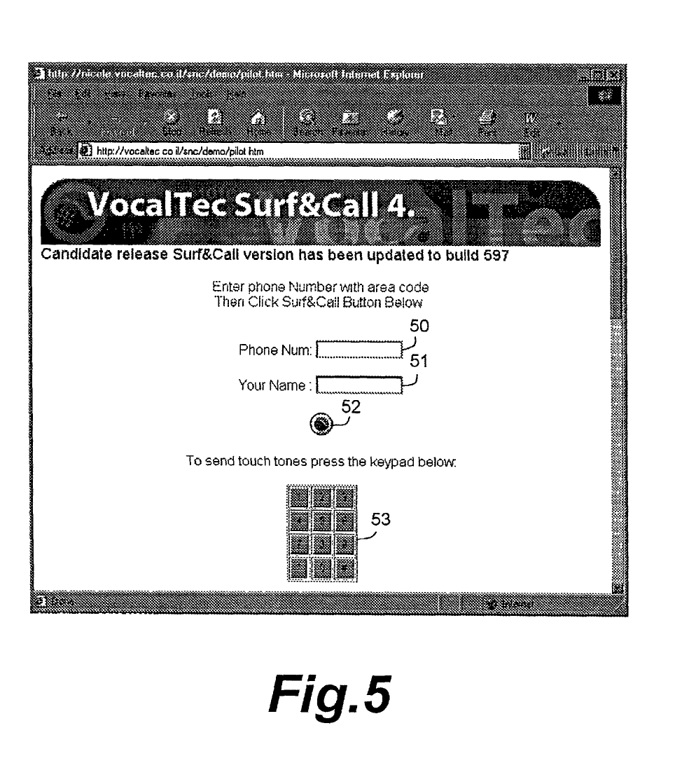

An example of a web page in accordance with the invention is shown in reference to FIG. 5. In Box 50 the user enter the destination number to call. In box 51 the user enters his name. To perform the call to the destination number of box 50, the user click on the button 51. The button 51 shows the progress of the call as it was described above with reference to FIG. 3. A number board 54 is used to enter for example an extension number or to follows the instructions of interactive voice response (IVR) system.

While preferred embodiments of the present invention have been described so as to enable one of skill in the art to practice the present invention, the preceding description is exemplary only, and should not be used to limit the scope of the invention. The scope of the invention should be determined by the following claims.

What is claimed is:

1. A communication system for performing telephone calls over hybrid network, which network includes a combination of at least one of a public switched telephony network (PSTN) and a local area network (LAN) with a wide area network (WAN), wherein the system comprising:
a computer system having an Internet browser application for browsing the internet, at least one audio input device, at least one audio output device and a communication device for communicating with said hybrid network;
a telephony communication means operably coupled to a web page which displayed by said Internet browser for performing telephone calls;
an addressing server links to the WAN for resolving telephony call parameters and providing at least one address of a bridging device; and
the bridging device is operably coupled to the WAN and the PSTN for receiving a destination parameters from said communication means and for delivering said parameters to the PSTN for establish a telephone call.

2. The communication system of claim 1, wherein said telephony call parameters are download from said web page to said telephone communication means.

3. The communication system of claim 2, wherein said addressing server is locating said bridging device address and providing said bridging device address to the telephony communication means.

4. The communication system of claim 3, wherein said telephony communication means are linking to said bridging device by said bridging device address and transfer a telephone destination parameters to said bridging device.

5. The communication system of claim 4, wherein said bridging device transfers at least one of destination number and Internet protocol (IP) address to PSTN for establishing telephone call.

6. The communication system according to claim 1, wherein the telephony communication means comprises a software application which links to said web page.

7. The communication system of claim 6, wherein the telephony application means comprises:
a voice encoder for converting analog voice to digital signals;
a voice decoder for converting digital signal to voice; and
a graphical universal interface (GUI) which links to said web for activating said telephony communication means.

8. The communication system of claim 7, wherein said GUI is a button and pressing on said button is for activating or deactivating the telephony communication means.

9. The communication system of claim 8, wherein said button comprises animation for displaying a telephone call status.

10. The communication system according to claim 1, wherein the web page comprises a telephone number and by pressing on said button establishing a telephone call to a destination provided by said telephone number.

11. The communication system according to claim 1, wherein the web page comprises an Internet protocol (IP) address and by pressing on said button establishing a telephone call to a destination provided by said IP address.

12. A method for performing telephone calls over hybrid network, which network includes a combination of at least one of a public switched telephony network (PSTN) and a local area network (LAN) with a wide area network (WAN), wherein the method comprising the steps of:
browsing said WAN to a virtual site which includes a telephony call parameters;
downloading said telephony call parameters by a telephony communication means;
contacting an addressing bridging device links to the WAN for resolving said telephony call parameters for providing a telephone call destination parameters;
contacting to a bridging device which is operably coupled to the addressing server and links to the WAN and to the PSTN for receiving said destination parameters; and
delivering said parameters to the PSTN for establishing said telephone call.

13. The method of claim 12, wherein said telephony call parameters are download from said web page by said telephone communication means.

14. The method of claim 13, wherein said addressing serve is locating and providing said bridging device address to the telephony communication means.

15. The method claim 14, wherein said telephony communication means are linked to said bridging device by said bridging device address for transfering said telephone destination parameters.

16. The method of claim 15, wherein the telephone destination parameters includes a destination number and IP address and said bridging device transfers at least one of the destination number and the IP address to PSTN for establishing said call.

17. The method according to claim 12, wherein the telephony communication means includes an Internet telephony software application which links to said web page.

18. The method according to claim 12, wherein the bridging device transfers telephony parameters from the WAN to the PSTN.

19. A method for establishing a telephone call from a web page, wherein the method comprising the steps of:
providing a destination parameters for establishing a telephone call;
downloading said parameters by a Internet telephony software application;
contacting to an addressing server for receiving a bridging device address;
contacting to said bridging device for providing said parameters; and
establishing a telephony call.

20. The method of claim 19, wherein the step of establishing further comprises the step of:
contacting a public switched telephony network by said bridging device; and
providing at least one of a telephone number and an IP address for establishing said telephone call.

21. The method according to any one claim 19, wherein the Internet telephony software application comprises a voice encoder, a voice decoder and a network communication device for communicating over the wide area network

22. The method according to claim 19, wherein the bridging device is for transferring telephony parameters from a wide area network to said public switched telephony network.

23. The method according to claim 19, wherein the wide area network is the Internet.
